(19) United States
(12) Patent Application Publication
(10) Pub. No.: US 2011/0012600 A1
(43) Pub. Date: Jan. 20, 2011

(54) ELECTROMAGNETIC ANTENNA AND METHOD OF USE FOR DETECTING OBJECTS

(76) Inventor: Martin C. Connor, Melbourne, FL (US)

Correspondence Address: McDermott Will & Emery, 600 13th Street, NW, Washington, DC, 20005-3096, US

(21) Appl. No.: 12/833,391

(22) Filed: Jul. 9, 2010

Related U.S. Application Data
(60) Provisional application No. 61/225,329, filed on Jul. 14, 2009.

(51) Int. Cl. G01V 3/11

(52) U.S. Cl. 324/326

(57) ABSTRACT

Disclosed herein are systems and methods of detecting objects. In particular, a transmitter antenna is disclosed comprising one or more coils. Alternating current may be run through the one or more coils of the antenna to create an electro-magnetic field (“EMF”) which will, in turn, induce an alternating current in objects near the EMF(s). As a result of the induced alternating current in the hidden object, a second EMF is generated around the hidden object which may be detected by a receiver, indicating the location of the hidden object. The transmitter antenna may be elongated and flexible to permit deploying the antenna in a configuration facilitating location of all utilities in an area of investigation with little or no relocation of the antenna.

### RELATED APPLICATIONS

This application is based upon and claims priority to U.S. Provisional Application Ser. No. 61/225,329, filed Jul. 14, 2009, the entire content of which is incorporated herein by reference.

### FIELD OF THE DISCLOSURE

The present disclosure generally concerns locating objects. More specifically, this disclosure relates to systems and methods for locating objects by inducing electrical current in the object or tracer wire corresponding to the object. In one example, the disclosed systems and methods locate utilities buried underground.

### BACKGROUND OF THE DISCLOSURE

Utilities, such as those housed in cables, pipes, ducts, or other similar modes of transmission or objects, are often installed in a manner to be hidden from sight. Hidden installation is often desirable for reasons such as to preserve scenery or to lower maintenance costs. A drawback to this hidden installation, however, is the need to locate or expose the utilities for maintenance and repair or to avoid a pre-existing utility during excavation, such as the installation of another utility. While records and maps of installation may be suitable for generally locating utilities, these documents arc usually not reliable for the precise location of utilities for these purposes. Accordingly, basic systems and methods for locating hidden or underground utilities have been developed. One system and method of toning is described in published patent application number US 2008/0129622 A1, the entirety of which is incorporated herein by reference.

A common approach to locating an underground or otherwise hidden utility is to introduce an alternating current in the utility with a transmitter. Once an alternating current flows in the utility, an electromagnetic field (hereinafter “EMF”) is induced along the length of the utility, which is then sensed by a receiver to locate and trace the hidden utility. In the example of utilities buried underground, the transmitter and receiver are located above ground, the transmitter induces alternating current in the underground utility, this in turn creates an EMF along the length of the utility and the EMF is sensed by the receiver located above ground, to identify the location of the utility.

Sometimes, a tracing wire is run along the length of the utility to allow the introduction of an alternating current, which creates an EMF that is detectable by the receiver. A tracing wire is particularly useful where it is not possible to induce a current directly onto the utility, such as with polymeric piping or conduit. Reference herein of inducing current in a utility, locating a utility, or tracing a utility apply equally to doing so with such a tracing wire.

Currently, three approaches are generally used to locate or trace a utility in this manner. The first is a direct connect approach, where a transmitter is directly connected to an above ground terminal in contact with the underground utility or tracing wire. Through this direct connection, the transmitter sends alternating current through the utility creating an EMF. An above ground receiver is then used to detect that EMF and, thus, the location of the underground utility.

A second approach (known as induction) is useful when the location of at least one part of the utility is known, but is underground. Because this utility is not easily accessible, the transmitter cannot be directly connected to the utility to introduce alternating current as in the previous approach. In this second approach, the transmitter emits an EMF which is directed, at least in part, towards a single point of the inaccessible utility (e.g. into the ground) so as to encounter the hidden utility and induce an alternating current therein. This “point” type transmitter emits an EMF towards only a single location. That alternating current runs the length of the utility creating its own EMF there along which can be sensed and traced by a receiver. This approach is sometimes referred to as induction.

When no information is known about the location of a utility, a third approach is required. In this third approach, sometimes referred to as a “two person sweep,” two people sweep the area of inspection to detect a utility—one attempting induction with the “point” type transmitter described above at various locations, and the other attempting to locate the resulting re-emitted EMF signal with a receiver. This is a long and tedious process requiring much skill and patience to locate and trace each hidden utility. If the “point” type transmitter happens to be placed over a part of the utility—and induces an alternating current on said utility, then the receiver will sense the resulting EMF in another part of the utility—if the receiver also happens to be over another part of the same utility. The receiver and transmitter must both be in-line with the hidden utility in order to detect the utility. The two people must sweep the area in swaths to locate the utility. Once the utility is detected, then the transmitter can be held stationary while current is induced in the length of the utility and the receiver can be used to detect and trace the utility along its length. One stage of the two man sweep approach applied to a search for underground utilities is depicted in FIG. 1, in which one person positions a transmitter 130 and a second person positions a receiver 120 in order to locate a utility that is running below and between the transmitter 130 and receiver 120. FIG. 1 depicts a utility 110 that is not under the transmitter 130 or receiver 120 and will not, therefore, be detected. The sweep continues until both the transmitter 130 and receiver 120 are positioned over the utility 110 to allow the transmitter 130 to induce an alternating current via an EMF emitted from the transmitter 130, and the receiver 120 to detect the resulting EMF emitted by the utility 110 as a result of the alternating current induced by the transmitter 130.

The two person sweep approach requires two people and a significant amount of time to locate each utility. Because the receiver must be placed a certain distance away from the transmitter to prevent detection of the transmitter's EMF instead of the EMF induced in the utility, coordinating the transmitter and receiver is difficult. For example, Ridgid® recommends its SeekTech® ST-510 Line Transmitter to be placed at least 20 feet away from the receiver to prevent erroneous positive readings due to this “air coupling” resulting from the receiver's reception of the transmitter's EMF.

### SUMMARY OF THE DISCLOSURE

It is to be understood that both the foregoing summary of the present disclosure and the following detailed description are exemplary and explanatory and are not intended to limit the scope of the present disclosure. Moreover, with regard to terminology used herein, a reference to an element in the singular is not intended to mean “one and only one” unless specifically stated, but rather “one or more.” The term “some” refers to one or more. Underlined and/or italicized headings and subheadings are used for convenience only, do not limit the present disclosure, and are not referred to in connection with the interpretation of the description of the present disclosure.

An aspect of the present disclosure provides systems and methods for locating objects. More specifically, the disclosure provides for a method of using an antenna comprising a plurality of coils to locate an object comprising the steps of: deploying the antenna proximate to a location of the object; arranging the antenna such that at least one portion of the antenna is proximate to the object; transmitting an alternating current through at least one of the coils in the antenna; and scanning the area of investigation with a receiver to detect a resulting electromagnetic field emanating from the utility.

The arranging step can include placing the antenna on the ground in the area of investigation such that at least one portion of the antenna is orthogonal to another portion of the antenna.

At least one of the one or more coils can be a loop antenna. At least one of the one or more coils can be an induction coil.

At least one of the one or more coils can be shielded to prevent the electro-magnetic field from being detected by the receiver through the air.

The antenna may comprise at least two coils that are supplied with the alternating current. The at least two coils can be supplied with the alternating current simultaneously. The antenna may comprise at least two coils that can be supplied with the alternating current sequentially. Logic circuitry can control the delivery of the alternating current to the at least two coils. The logic circuitry can be contained within a control box. The logic circuitry can be contained within the alternating current transmitter. The logic circuitry can be contained within the antenna.

The one or more coils can be provided with the alternating current by way of a relay. A control box can include the relay. The relay can be a solid-state relay.

The antenna may comprise at least two coils that are spaced at least one foot apart when the antenna is arranged in a linear arrangement.

The alternating current can be transmitted at a frequency of 33 kHz. The antenna can include one or more coil optimized to operate with an alternating current having a frequency of 1 kHz, 8 kHz, 33 kHz, or any other user-defined frequency.

The antenna can include an indicator to indicate which of the one or more coils is receiving the alternating current.

The antenna can be housed within a flexible sheath for permitting the arbitrary arrangement or positioning of the antenna.

Another aspect of the present disclosure provides for an antenna system for use in detecting an object in an area of investigation, comprising: a power source for generating an alternating current; a first control wire for delivering the alternating current; a second control wire for delivering the control logic; and one or more coils, in electrical communication with the control wire to receive the alternating current, that create a signal current in the object for detection at a receiver if one part of the object is proximate to at least one of the one or more coils and the receiver is proximate to another part of the object.

The antenna system can further comprise a flexible sheath to house the one or more coils for arranging the apparatus to maximize coverage of the area of investigation such that at least one portion of the antenna is proximate to the object.

At least one of the one or more coils can be a loop antenna. At least one of the one or more coils can be an induction coil.

At least one of the one or more coils can be shielded to prevent the electro-magnetic field from being detected by the receiver through the air.

The one or more coils may comprise at least two coils that can be supplied with the alternating current simultaneously. The at least two coils can be supplied with the alternating current sequentially. The antenna system can further include logic circuitry to control the delivery of the alternating current to the at least two coils. The logic circuitry can be contained within a control box. The logic circuitry can be contained within the sheath. The logic circuitry can be contained within the power source.

The one or more coils can be provided with the alternating current by way of a relay. A control box can include the relay. The relay can be a solid-state relay.

The one or more coils may comprise at least two coils that are spaced at least one foot apart when the sheath is arranged linearly.

The power source can transmit the alternating current at a frequency of 33 kHz. The one or more coils can be optimized to operate with an alternating current having a frequency of 1 kHz, 8 kHz, or 33 kHz. The power source can also transmit the alternating current at a user-defined frequency.

The antenna system can also include an indicator to indicate which of the one or more coils is receiving the alternating current.

### BRIEF DESCRIPTION OF THE DRAWINGS

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 is an image illustrating the two person sweep approach to detecting a utility in an embodiment where the utility is located underground;

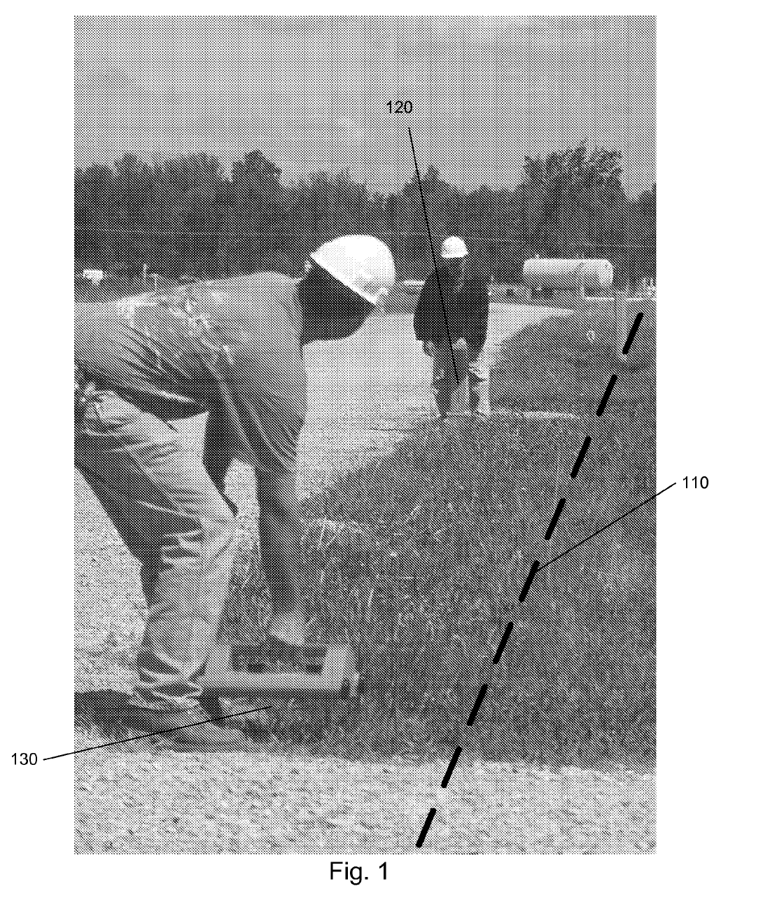

FIG. 2 shows an embodiment of a deployable antenna according to the present disclosure;

FIG. 3 illustrates the internal composition of an embodiment of an antenna in accordance with this disclosure; and

FIG. 4 demonstrates an approach to using an antenna to detect a buried utility in accordance with this disclosure.

While certain embodiments are depicted in the drawings, one skilled in the art will appreciate that the embodiments depicted are illustrative and that variations of those shown, as well as other embodiments described herein, may be envisioned and practiced within the scope of the present disclosure. Accordingly, the drawings and detailed description are to be regarded as illustrative in nature and not as restrictive.

### DETAILED DESCRIPTION OF THE DISCLOSURE

In the following detailed description, numerous specific details are set forth to provide a full understanding of aspects and embodiments of the present disclosure. It will be apparent, however, to one ordinarily skilled in the art that aspects and embodiments of the present disclosure may be practiced, without some of these specific details. In other instances, well-known structures and techniques have not been shown in detail to for ease in comprehension.

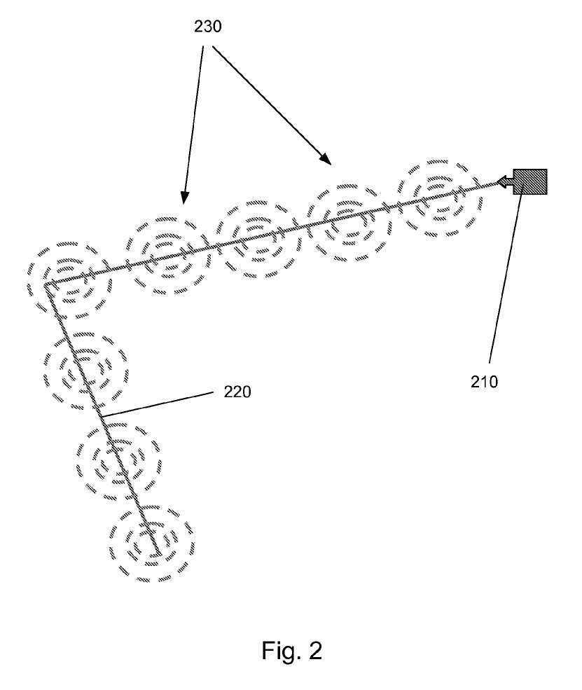

This disclosure relates to improved systems and methods for detecting objects, such as utilities, by way of inducing alternating current into the objects and detecting the resulting EMF. In general, according to one aspect of this disclosure, a transmitter antenna 220 is provided to create one or more EMFs 230 along all or part of its length, as shown in FIG. 2. The antenna 220 acts as an elongated transmitter, emitting one or more EMFs 230 along all or part of its length creating the ability to induce alternating current in any utility lying anywhere under the antenna 220, rather than at just a single point as in the prior art. The control box 210 controls which coils 320 receive current (i.e. are “triggered”) so that the coils can be triggered sequentially, in combinations, in unison, or otherwise.

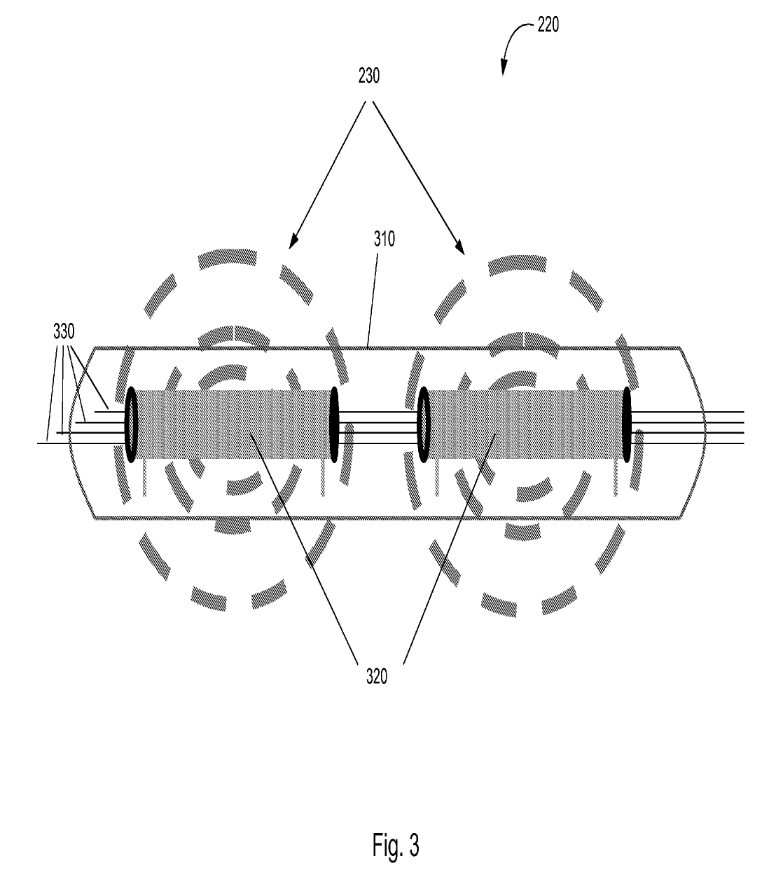

In one embodiment, depicted in FIG. 3, the antenna 220 includes a sheath 310 which houses one or more coils 320 which create EMFs 230. This embodiment of the antenna 220 includes at least two coils 320 and associated control lines 330. In alternate embodiments, various types of coils may be used. The copper coil types identified in Table 1 were used in experimental testing.

TABLE 1
Tested Coil Types

| Coil Type | Windings | Gauge | Total Length |
|---|---|---|---|
| Coil from Radiodetection | 73 | 22 gauge | 225 ft. |
| RD433-HCTx | | | |
| Spool of Wire | 276 | 12 gauge | 239 ft. 9 in. |
| Induction Coil | 33 | 16 gauge | 40 ft. |
| | | | (estimated) |
| Modified Coil (Hand-made) | 73 | 22 gauge | 8 ft. |

In experimental testing on an underground telephone line using an induced frequency of 33 kHz, the RD433 induction coil antenna outperformed various other coils, as shown in Table 2. The signal strength was recorded using the Ridgid® SeekTech® SR-20 receiver, where the proximity signal is a numerical indication showing how close the receiver is to the hidden utility (a higher value means a closer proximity) and where the signal strength measures the strength of the received signal (a higher value means a stronger signal).

TABLE 2
Coil Test with Ridgid ® SeekTech ® ST-510
Transmitter at 33 kHz and 28 V_{AC}.

| | Received | Proximity | Signal |
|---|---|---|---|
| Antenna | Current | Signal | Strength |
| RD433 Coil | 0.22 mA | 224 | 664 |
| Spool of Wire | 0.13 mA | 230 | 400 |
| Induction Coil | 0.05 mA | 200 | 60 |
| Modified Coil | — | 20 | 16 |

The 33 winding induction coil was also tested using a transmitter frequency of 1 kHz and 8 kHz, but no significant performance improvement was detected as compared to using the 33 kHz test frequency.

The various coils 320 were tested to determine the detectable range of their EMFs 230 through the air. This provides an estimate of how deep a coil's EMF 230 could penetrate the ground. Because, in certain embodiments, a coil is not shielded to direct a created EMF downward only, a receiver may detect an EMF created by the coil through the air instead of an underground utility. Table 3 below indicates the detectable distance an EMF 230 was observed using a Ridgid SeekTech SR-20 receiver 120. Measurements were taken from both broad-side of the coil, as well as from directly in front of the antenna. The Ridgid Transmitter 130 was set to 33 kHz and a power level of 2 (approximately 2.0 Watts). It is noted that the Induction Coil 320 with 33 windings around a magnetic core had the best detectable range from the side. The Modified Coil 320 was not used in this test.

TABLE 3
Detectable Distance Through the Air

| | From the Front | From the Side |
|---|---|---|
| Coil Type | (Along axis of coil) | (Orthogonal to Coil) |
| RD433 Coil | 7 ft. | 8 ft. 6 in. |
| Spool of Wire | 7 ft. | 8 ft. |
| Induction Coil | 6 ft. | 16 ft. |

In various embodiments, the coils 320 may be shielded to direct the EMF towards the hidden utility. Such a shielding focuses the EMF 320 towards the hidden utility and also prevents the EMF 320 from emitting into the air. In one embodiment, this shield may be made with metalized mylar foil.

Antenna testing was also performed on a 24 inch steel drain pipe located three feet underground. Using a transmitter frequency of 33 kHz signal at 28 V_{AC}, the pipe was detected using the loop antenna, the coil of wire, and the 33 winding induction coil described above. The 33 winding induction coil was able to detect the induced signal emanating from the buried pipe when the receiver was positioned 100 feet away from the coil antenna.

The control lines 330 carry the current to energize the coils 320 to create the EMFs 230. The control lines 330 also carry the control signals that designate which coils will be triggered and when that triggering occurs. Thus, the EMFs 230 generated by the coils can be generated in sequence, simultaneous, or in various combinations thereof.

The coils 320 of the antenna 220 can be spaced at an optimal distance apart from each other to maximize efficiency such as by minimizing overlap of EMFs of adjacent coils 320. In this example, the distance between coils 320 will vary based on the size of the EMF generated by the selected coils 320. In one example, the coils 320 can be spaced approximately one foot apart from each other to prevent significant overlap of the EMFs they generate. If the loop antenna described above is used as a coil, however, four foot spacing may be sufficient: the loop antenna described above was tested at a transmitter frequency of 33 kHz over an underground telephone line at one foot and two foot distances orthogonal to an underground utility line, and the results are shown in Table 4.

TABLE 4
Signal Strength Received Compared to Transmitter Distance from Utility

| Offset | Received Current | Proximity Signal | Signal Strength |
|---|---|---|---|
| −2 ft. | 0.15 mA | 193 | 374 |
| −1 ft. | 0.19 mA | 215 | 536 |
| 0 ft. | 0.23 mA | 223 | 677 |
| 1 ft. | 0.20 mA | 218 | 575 |
| 2 ft. | 0.15 mA | 197 | 385 |

Moreover, the number of coils 320 of the antenna 220 can vary based on the circumstances. For instance, the antenna 220 can house hundreds of coils 320. Also, the timing of a full cycle of triggering all coils 320 in the antenna 220 can vary depending on the application. For example, triggering a full sequential cycle of eight coils 320 can be operated at a one second cycle time.

The characteristics of each coil 320 can be optimized based on the frequencies on which the transmitter 130 and receiver 120 operate. Typically, transmitters 130 expected to be used with the antenna 220 operate at 1 kHz, 8 kHz, or 33 kHz. Accordingly, the coils 320 can be optimized to operate at each operating frequency, or, optionally, at 12 kHz to maximize compatibility with most types of commercial transmitters 130. Alternatively, the coils 320 can be optimized based on each transmitter operating frequency. Thus, for example, the coils 320 can be specifically optimized for 1 kHz, 8 kHz, or 33 kHz. In another embodiment, the antenna 220 can comprise coils 320 optimized for multiple frequencies. For example, the antenna 220 may have six coils 320, two optimized at each of 1 kHz, 8 kHz, and 33 kHz. As stated previously, each coil 320 can also have RF shielding on the coil's top side. This shielding could focus the EMF 320 into the ground, as well as prevent the EMF 320 from emitting into the above ground airspace.

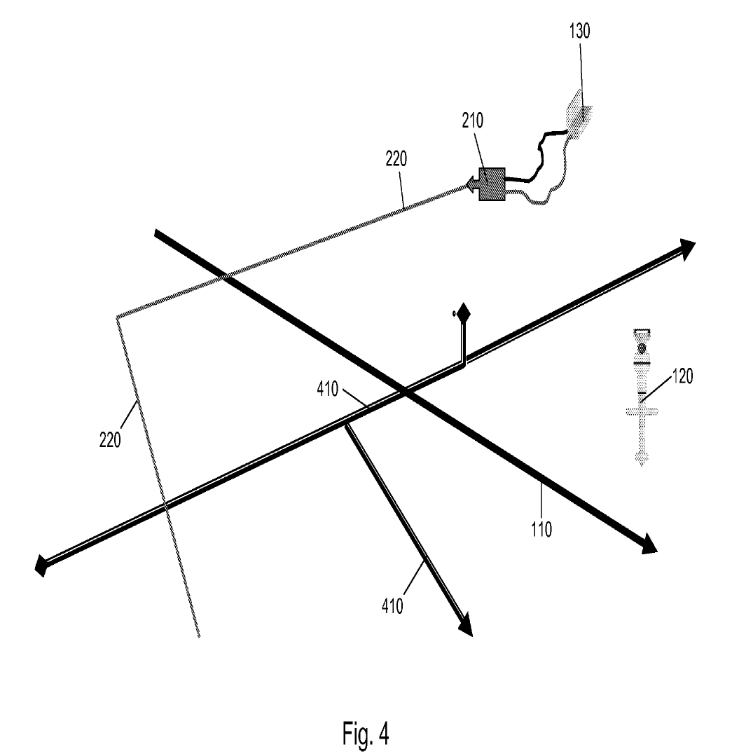

In the embodiment shown in FIG. 4, the control box 210 includes logic circuitry to sequentially, individually or in combination, or simultaneously “trigger” each of the coils 320 in the antenna 220. The control box 210, for example, can include a controller and relays, whether mechanical, solid state, optical, or otherwise, to sequentially “trigger” each coil by passing through the transmitter 130 signal to each sequential coil 320. Electronic switching is preferred over mechanical switching in various embodiments. The logic circuitry, including the controller and relays, can be powered by any source, such as a 12V battery.

In one embodiment, the systems and methods of this disclosure can also be practiced by inserting control logic into the antenna 220 itself, instead of requiring a control box 210. Logic circuitry can be installed between the coils 320 in the antenna 220 to sequentially trigger the coils 320 to emit EMFs 230. A separate control box 210 is not necessary in such an embodiment.

In an alternate embodiment, the systems and methods of this disclosure can also be practiced by combining the control box 210 into the transmitter assembly 130 itself. Control logic 210 can be combined with the transmitter 130 circuitry. The transmitter 130 power source could also provide the power required by the control logic. By doing so, a separate control box 210 is not necessary in such an embodiment.

The antenna 220 can also include an indicator, audible, visual, or otherwise, to signify that all selected coils 320 have been cycled through. Such an audible or visual indicator can be helpful to the operator of the systems and methods herein when using a receiver 120 so that the operator will know when to move the receiver 120 to another location to search for a utility 110 of interest.

The coils 320 and control wires 330 can be housed in a sheath 310. The sheath 310 can be flexible or rigid and can be of any shape or length. In one example, the sheath is preferably constructed of a synthetic rubber or soft plastic, like that of a garden hose. With such a flexible material, the antenna can be formed and shaped into different formations. Further, the sheath can be constructed of a material with memory, such that it will more easily hold a shape formed by the user of the antenna 220. Flexibility in all or portions of the antenna 220 eases transportability, such as by coiling, and allows the antenna 220 to be deployed in a configuration that will optimize coverage of the area of investigation reducing or eliminating the need to relocate the antenna 220 to locate all utilities. Intelligently configuring the antenna 220 and choosing an antenna 220 of appropriate length can induce an alternating current in every utility in an area of investigation. The antenna 220 can also be semi-rigid. Semi-rigidity allows the antenna 220 to be inserted into a pipe of irregular shape, permitting system and method for determining the pipe's shape, length, and depth. This includes the system and method of sensing and receiving any of the coil's 320 EMF 230 directly. In alternate embodiments, the sheath can take any other shape as may be required by the shape of various other induction coils, like a loop antenna or a spool of wire, as described above.

FIGS. 2 and 4 depict antenna configurations that optimize coverage of an area. In the embodiment depicted in FIG. 4, the antenna 220 will induce current in utilities 110 and 410 without having to be relocated. In the configuration depicted in FIG. 4, the transmitter 130 can be a commercial transmitter which is connected to the control box 210 and which provides the transmitting signal to the coils 320 in the antenna 220. The control box 210, in turn, designates which coils 320 in the antenna 220 are triggered to create an EMF 230. A current will be induced in any utility 110 or 410 within that EMF. The induced current in the utility 110 or 410 creates a corresponding EMF along the utility which the receiver 120 detects. With this configuration, after the transmitter 130, control box 210, and antenna 220 are arranged, the receiver 120 can be moved to trace and locate utilities 110 with minimal or no repositioning of the antenna 220.

In alternate embodiments, the antenna 220 may take other shapes. For example, the antenna 220 may have a tree-like architecture with a “trunk” and a number of branches to more widely distribute the coils. Alternatively, the antenna 220 may take a finger-like or spoke-like shape. In yet another embodiment, the antenna 220 can comprise one or more large or elongated coils to be arranged over an area of investigation to locate an object as described herein.

In some embodiments, the transmitter 130 can be any commercial transmitter 130 with leads to affix to a control box 210. Such commercial transmitters 130 include Ridgid®'s SeekTech® ST-510 and SeekTech® ST-305 transmitters. In alternate embodiments of this disclosure, however, the transmitter 130 and the control box 210 can be housed in the same unit with the antenna 220 connected thereto.

The embodiments disclosed herein can be practiced using any commercial or proprietary receiver 120. For example, the EMFs induce in a utility 110 can be detected using receivers 120 such as the Ridgid® SeekTech® SR-20.

The benefits of the disclosed systems and methods are not limited to detecting utilities 110. Instead, these systems and methods can be beneficial in any circumstance where a current can be induced in a object needing to be detected. For example, the disclosed systems and methods can aid in locating and tracing pipes within a large building, or to aid in the detection of underground storage tanks, munitions, or unexploded ordnances.

While the disclosure makes reference to the details of specific embodiments, the disclosure is intended to be illustrative rather than limiting. Modifications will readily occur to those skilled in the art, within the spirit of this disclosure. Further, the examples provided herein are intended to illustrate sample embodiments contemplated in the present disclosure and are not exhaustive in nature.

What is claimed is:

1. A method of using an antenna comprising one or more coils to locate an object comprising the steps of:
deploying the antenna proximate to a location of the object;
arranging the antenna such that at least one portion of the antenna is proximate to the object;
transmitting an alternating current through at least one of the coils in the antenna; and
scanning the area of investigation with a receiver to detect a resulting electromagnetic field.

2. The method of claim 1 wherein the electromagnetic field to be detected emanates from the object.

3. The method of claim 1 wherein the arranging step comprises placing the antenna on the ground in the area of investigation such that at least one portion of the antenna is orthogonal to another portion of the antenna.

4. The method of claim 1 wherein at least one of the one or more coils is an induction coil.

5. The method of claim 1 wherein at least one of the one or more coils are shielded to prevent the electro-magnetic field from being detected by the receiver through the air.

6. The method of claim 1 wherein the antenna comprises at least two coils which are supplied with the alternating current sequentially.

7. The method of claim 5 wherein logic circuitry controls the delivery of the alternating current to the at least two coils.

8. The method of claim 1 wherein the one or more coils are supplied with the alternating current by way of a relay.

9. The method of claim 1 wherein the antenna comprises at least two coils that are each spaced at least one foot apart when the antenna is arranged in a linear arrangement.

10. The method of claim 1 wherein the antenna is housed within a flexible sheath to permit the selected arrangement or positioning of the antenna in the arranging step.

11. An antenna system for use in detecting an object in an area of investigation, comprising:
a power source for generating an alternating current;
a first control wire for delivering the alternating current;
a second control wire for delivering the control logic; and
one or more coils, in electrical communication with the control wire to accept the generated alternating current for detection of an electromagnetic field at a receiver if a receiver is proximate to at least a portion of the object.

12. The method of claim 11 wherein the electromagnetic field to be detected emanates from the object.

13. The antenna system of claim 11, further comprising a flexible sheath to house the one or more coils for arranging the apparatus to maximize coverage of the area of investigation such that at least one portion of the antenna is proximate to the object.

14. The antenna system of claim 11, wherein the one or more coils comprises one elongated coil of sufficient length to be arranged over an area of investigation.

15. The antenna system of claim 11 wherein at least one of the one or more coils is shielded to prevent the electro-magnetic field from being detected by the receiver through the air.

16. The antenna system of claim 11 wherein the one or more coils comprises at least two coils that are supplied with the alternating current sequentially.

17. The antenna system of claim 11 further comprising logic circuitry to control the delivery of the alternating current to the one or more coils.

18. The antenna system of claim 11 wherein the one or more coils are provided with the alternating current by way of a relay.

19. The antenna system of claim 11 wherein the one or more coils comprises at least two coils spaced at least one foot apart when the sheath is arranged linearly.

20. The antenna system of claim 11 wherein the power source transmits the alternating current at a user-defined frequency.
